(19) United States
(12) Patent Application Publication
(10) Pub. No.: US 2015/0382129 A1
(43) Pub. Date: Dec. 31, 2015

(54) DRIVING PARAMETRIC SPEAKERS AS A FUNCTION OF TRACKED USER LOCATION

(71) Applicant: MICROSOFT CORPORATION, REDMOND, WA (US)

(72) Inventors: Dinei Florencio, Bellevue, WA (US); Zhengyou Zhang, Redmond, WA (US)

(21) Appl. No.: 14/319,708

(22) Filed: Jun. 30, 2014

(51) Int. Cl. H04S 7/00; H04R 5/033; H04R 5/04; H04S 1/00

(52) U.S. Cl. CPC H04S 7/303; H04S 1/002; H04R 5/0335; H04R 5/04; H04S 2400/09; H04S 2420/01

(57) ABSTRACT

Described herein are various technologies pertaining to parametric speakers. A parametric speaker is driven based upon a determined location of an ear of a listener. The parametric speaker outputs an ultrasonic beam that comprises several modulated signals, the modulated signals being carrier signals modulated by an audio signal. The parametric speaker is driven such that a main lobe of the ultrasonic beam has a focal point between the ear of the listener and the parametric speaker.

### BACKGROUND

Conventional audio speakers are configured to spread sound over a fairly wide area. Oftentimes, this spreading of sound is desirable; for instance, in a movie theater or outdoor concert venue, it is generally desirable for each person to receive audio emitted by speakers, since these venues provide a shared listening experience. In some scenarios, however, it may be desirable to provide a person with customized sound, where the person can hear the sound while another person in relative close proximity to the person cannot hear the sound or hears different sound. An exemplary approach for providing a person with customized sound requires the use of headphones, where the sound is delivered to speakers inserted into or covering ears of the person. Headphones, however, can be somewhat uncomfortable to wear (particularly for long time durations), and may preclude certain types of social interaction.

To provide a headphones-like experience to users, audio systems have been developed that are configured to cancel crosstalk between left and right audio signals. These audio systems, however, are less than ideal, as room reverberation and individual variations in head shape render effective crosstalk cancellation difficult.

### SUMMARY

The following is a brief summary of subject matter that is described in greater detail herein. This summary is not intended to be limiting as to the scope of the claims.

A system that is configured to drive a parametric speaker is described herein. The system includes a location component that is configured to compute a location of an ear of a listener relative to the parametric speaker. The system further includes a steer circuit that is configured to transmit drive signals to the parametric speaker, the drive signals cause the parameteric speaker to emit an ultrasonic beam toward the ear of the listener. The ultrasonic beam includes a plurality of modulated signals, the modulated signals being ultrasonic carrier signals modulated by an audio signal. The drive signals are based upon the location computed by the location component. A main lobe of the ultrasonic beam has a focal point between the parametric speaker and the ear of the listener.

### BRIEF DESCRIPTION OF THE DRAWINGS

FIG. 1 is a functional block diagram of an exemplary system that facilitates directing an audio signal to an ear of a listener.

FIG. 2 is a functional block diagram of an exemplary steer circuit that is configured to steer a main lobe of an ultrasonic beam towards an ear of a listener.

FIG. 3 is a functional block diagram of an exemplary system that facilitates providing a listener with a three-dimensional audio experience by directing audio signals to ears of a listener.

FIG. 4 illustrates an ultrasonic beam that is formed to have a focal point between a parametric speaker and an ear of a listener, and is further formed such that a null region of the ultrasonic beam encompasses a second listener.

FIG. 5 illustrates an exemplary environment where utilization of parameter speakers may be particularly beneficial.

FIG. 6 illustrates a mobile telephone driving a parametric speaker to cause an audio beam to be directed towards an ear of a listener.

FIG. 7 is a flow diagram that illustrates an exemplary methodology for driving transducers of parametric speakers to cause a main lobe of an ultrasonic beam to be steered towards an ear of a listener.

FIG. 8 is a flow diagram that illustrates an exemplary methodology for forming an ultrasonic beam such that a main lobe of the beam is directed towards an ear of a first listener and a null region encompasses a second listener.

FIG. 9 is a flow diagram that illustrates an exemplary methodology for providing a three-dimensional audio experience to a listener without use of headphones.

FIG. 10 is a flow diagram that illustrates an exemplary methodology for providing virtualized sound to a listener.

FIG. 11 is an exemplary computing system.

### DETAILED DESCRIPTION

Various technologies pertaining to driving parametric speakers based upon monitored locations of ears of listeners are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, and “circuit” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. The terms “component”, “system”, and “circuit” are also intended to encompass hardware circuits (e.g., an application-specific integrated circuit (ASIC)) that are configured to perform particular functionality. Further, as used herein, the term “exemplary” is intended to mean serving as an illustration or example of something, and is not intended to indicate a preference.

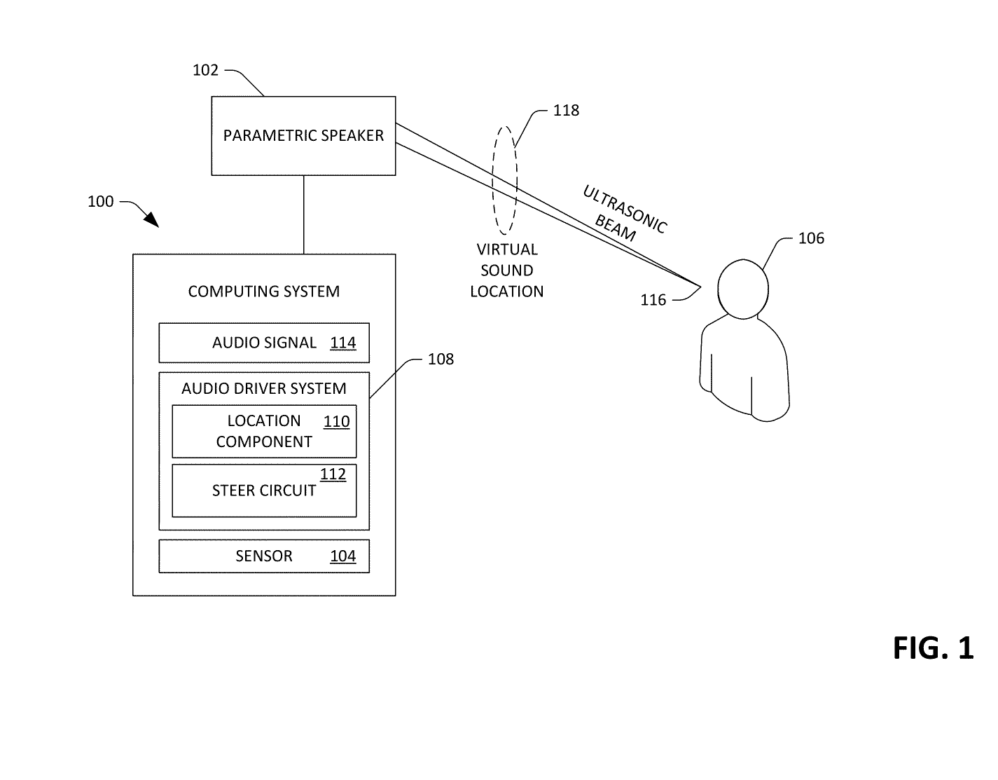

With reference now to FIG. 1, an exemplary computing system 100 that is configured to drive a parametric speaker 102 is illustrated. The parametric speaker 102 is in communication with the computing system 100, for example, by way of a wireless or wireline connection. In another example, the computing system 100 may include the parametric speaker 102. For instance, the computing system 100 may be a telephone that includes the parametric speaker 102 (such as an office telephone or mobile telephone), a mobile telephone in wireless or wired communication with the parametric speaker 102, an audio receiver in communication with the parametric speaker 102, a videogame console that includes or is in communication with the parametric speaker 102, a television that includes or is in communication with the parametric speaker 102, a set top box that includes or is in communication with the parametric speaker 102, or the like. The parametric speaker 102 includes an array of piezoelectric transducers (not shown), which can be driven by the computing system 100 to emit an ultrasonic beam.

The computing system 100 includes or is in communication with a sensor 104 that is configured to output data that is indicative of a location of an ear (or locations of ears) of a listener 106 relative to a location of the parametric speaker 102. For example, the sensor 104 can be or include a video camera that outputs images of the region that includes the listener 106. Additionally or alternatively, the sensor 104 can be or include a depth sensor that outputs depth images of the region that includes the listener 106. In still yet another example, the sensor 104 can be or include stereoscopically arranged cameras that collectively output stereoscopic images of the region that includes the listener 106. Other sensors that can output data that is indicative of location(s) of listener(s) in a region that includes the parametric speaker 102 are also contemplated. Thus, the sensor 104 can output data that is indicative of location of the ear of the listener 106 relative to the sensor 104, and thus relative to the location of the parametric speaker 102 (e.g., where the location of the parametric speaker 102 may be known relative to the sensor 104).

The computing system 100 may also include an audio driver system 108 that is configured to drive the parametric speaker 102 based upon the location of the ear of the listener 106. The audio driver system 108 can include a location component 110 that computes location of the ear of the listener 106 relative to the location of the parametric speaker 102 based upon data output by the sensor 104. For instance, the location component 110 can receive video images and/or depth images from the sensor 104, and can compute the location of the ear of the listener 106 based upon the video images and/or depth images. As the location of the parametric speaker 102 may be known, the location component 110 can compute the location of the ear of the listener 106 relative to the location of the parametric speaker 102.

The location component 110 can additionally or alternatively compute the location of the ear of the listener 106 based upon other data. For instance, the listener 106 may carry a mobile telephone, wherein the mobile telephone can be configured to identify its location. A GPS transceiver in the mobile telephone can output location of the mobile telephone to the computing system 110, which can compute the location of the ear of the listener 106 relative to the parametric speaker 102 based upon the location received from the mobile telephone. In another example, the listener 106 may wear eyewear that has computing functionality built therein, wherein the eyewear can compute data that is indicative of its location. The eyewear can then transmit this location to the computing system 100, and the location component 110 can compute the location of the ear of the listener 116 relative to the parametric speaker 102 based upon the location data received from the eyewear.

The audio driver system 108 can further include a steer circuit 112 that is configured to cause the parametric speaker 102 to dynamically form and steer an ultrasonic beam based upon tracked location of the ear of the listener 106 relative to the parametric speaker 102. In an example, the steer component 112 can generate drive signals that drive transducers in the transducer array in the parametric speaker 102, wherein the drive signals act to electronically steer the ultrasound beam towards the ear of the listener 106. In another example, the parametric speaker 102 may include actuators that are configured to mechanically move the transducers of the parametric speaker 102. The steer component can generate drive signals that drive the actuators, such that an ultrasonic beam output by the parametric speaker 102 is mechanically steered based upon tracked location of the ear of the listener 106.

Additional detail pertaining to operation of the computing system 100 is now set forth. The computing system 100 can receive or retain an audio signal 114, which is representative of sound that is to be delivered to an ear of the listener 106. The audio signal 114 can be generated by the computing system 100 based upon an audio file retained on the computing system (e.g., an MP3 file, a WAV file, etc.). In another example, the audio signal 114 may be a streaming audio signal received from a computing device that is in network connection with the computing system 100. For example, the audio signal 114 can be received from a web-based music streaming service, a web-based video streaming service, etc. In yet another example, the audio signal 114 may be received by way of a telephone system (e.g., the plain old telephone system (POTS) or a web-based telephone system). In still yet another example, the audio signal 114 can be received from a broadcast source, such as a radio station, a television station, or the like.

The audio driver system 108 can receive the audio signal 114 and data from the sensor 104. The location component 110 identifies the current location of the ear of the listener 106 that is to receive the audio signal 114. The steer circuit 112 produces ultrasonic carrier signals for respective transducers in the parametric speaker 102. The steer circuit 112 then modulates the carrier signals by the audio signal 114 that is intended to be heard by the ear of the listener whose location has been identified by the location component 110, thus creating modulated signals. When the steer circuit 112 is configured to electronically steer an ultrasonic beam that is emitted from the parametric speaker 102, the steer circuit 112 can compute delay coefficients for the respective transducers in the parametric speaker 102. Pursuant to an example, the steer circuit 112 can compute the delay coefficients using the following algorithm.

delay coefficientᵢ=dᵢ cos(θᵢ)/c, (1)

where i refers to transducer i, dᵢ is a distance from transducer i in the transducer array to the center of the array, θᵢ is the angle between the vector from the center of the array to transducer i and the vector from the center of the array to the desired location, and c is the speed of sound.

The steer circuit 112 then drives the transducers of the parametric speaker 102 by transmitting the modulated signals, with delays based upon the computed delay coefficients, to the transducers of the parametric speaker 102. The parametric speaker 102, responsive to receiving the modulated signals, outputs an ultrasonic beam, where a main lobe of the beam is steered towards the ear of the listener 106.

When the parametric speaker 102 includes actuators that can mechanically move the steer circuit 112, the steer circuit need not compute the delay coefficients. Instead, the steer circuit 112 produces ultrasonic carrier signals and modulates the signals by the audio signal 114, thus generating modulated signals. The steer circuit 112 receives the location of the ear of the listener 106 relative to the parametric speaker 102 from the location component 110, and generates drive signals for the actuators based upon the received location. The steer circuit 112 transmits the drive signals to the actuators, and further transmits the modulated signals to the transducers of the parametric speaker 102. The actuators position the transducers of the parametric speaker 102 such that a main lobe of an ultrasonic beam formed by the transducers of the parametric speaker 102 is directed towards the ear of the listener 106. Thus, the steer circuit 112 can mechanically steer the ultrasonic beam.

In an example, as shown in FIG. 1, the steer circuit 112 can drive the parametric speaker 102 such that the ultrasonic beam has a focal point 116 that is between the parametric speaker 102 and the ear of the listener 106. This is in contrast to how ultrasonic beams are conventionally formed by parametric speakers. Specifically, conventionally, parametric speakers form ultrasonic beams such that the main lobe is fairly narrow and extends for as long as possible. In contrast, the audio driver system 108 can drive the parametric speaker 102 such that the main lobe of the ultrasonic beam has the focal point 116 near the ear of the listener 106 (e.g., between 2 inches and ¼ of an inch from the ear of the listener 106). Proximate to the focal point 116, ultrasonic waves emitted from the transducers of the parametric speaker 102 collide, thereby demodulating the audio signal proximate to the ear of the listener 106.

In another example, the audio driver system 108 can drive the parametric speaker 102 such that a virtual sound location 118 is created between the parametric speaker 102 and the ear of the listener 106. Despite the parametric speaker 102 being the origin of the ultrasonic beam, the listener 106 will perceive that the sound originates from the virtual sound location 118. This can be accomplished, for example, by driving the parametric speaker 102 such that the ultrasonic beam is formed to have the focal point 116 at the virtual sound source 118. Accordingly, the audio driver system 108 can cause the virtual sound source 118 to be at virtually any position between the parametric speaker 102 and the ear of the listener 106. While the virtual sound source 118 is shown as being in-line with the parametric speaker 102 and the ear of the listener 106, it is to be understood that in some cases it may be desirable to place the virtual sound source 118 out of alignment between the parametric speaker 102 and the ear of the listener 106. This can be accomplished by steering the main lobe of the ultrasonic beam in a direction away from the ear of the listener 106, and forming the beam such that the focal point 116 is at the desired position of the virtual sound source 118.

Furthermore, in an example, the parametric speaker 102 can output multiple ultrasonic beams directed towards different locations. For example, the parametric speaker can include a transducer array, wherein some transducers in the transducer array can be driven to direct an ultrasonic beam towards a first location (e.g., a first ear of the listener 106), while other transducers in the transducer array can be driven to direct an ultrasonic beam towards a second location (e.g., a second ear of the listener 106).

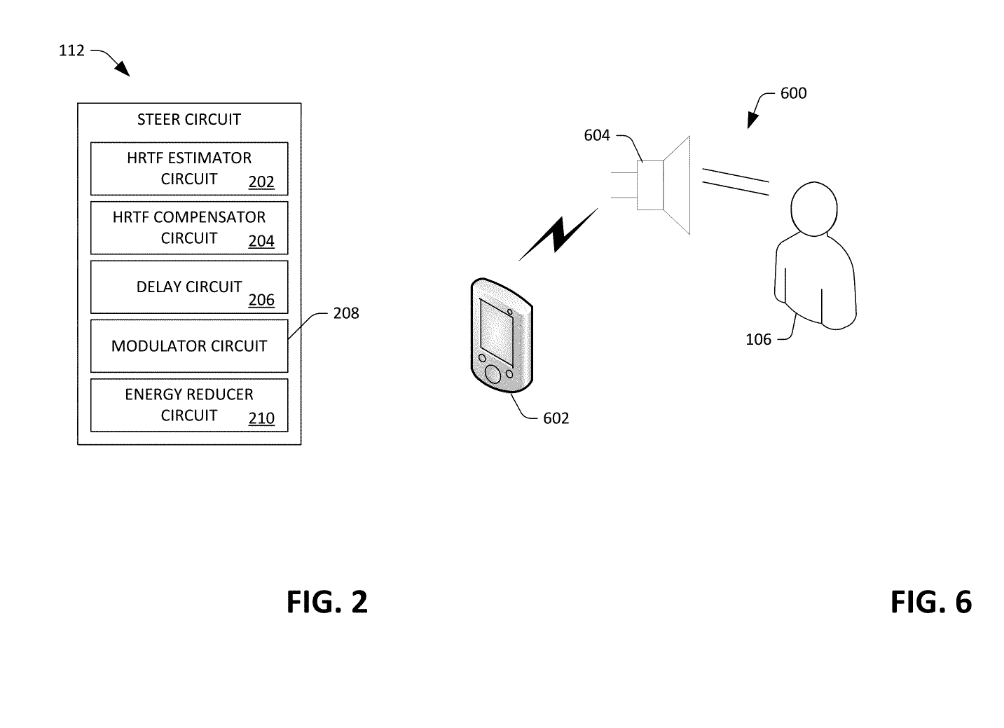

Now referring to FIG. 2, a functional block diagram of the steer circuit 112 is illustrated. The steer circuit 112 comprises a head related transfer function (HRTF) estimator circuit 202 that is configured to estimate a HRTF for an ear of the listener 106 (e.g., based upon the location of the ear of the listener 106 relative to the location of the parametric speaker 102). Additionally, the HRTF estimator circuit 202 can estimate a HRTF for another ear of the listener 106. A HRTF is a response that characterizes how an ear receives a sound from a point in space. A HRTF estimated by the HRTF estimator circuit 202 can be based upon a general model of human heads and/or bodies, or can be customized for the listener 106 (e.g., based upon images of the listener 106 output by the sensor 104).

The steer circuit 112 also includes an HRTF compensator circuit 204 that is configured to modify the audio signal 114 that is to be delivered to the ear of the listener 106 based upon an HRTF estimated by the HRTF estimator circuit 202. In an example, in some situations, it may be desirable for the listener 106 to perceive certain spatial effects typically associated with sound. When the parametric speaker 102 is configured to direct the main lobe of the ultrasonic beam to the ear of the listener 106, the spatial effects may be lost (except for directionality of the sound). Accordingly, the HRTF compensator circuit 204 can, for example, apply a HRTF estimated by the HRTF estimator circuit 112 to the audio signal 114, such that the listener 106 perceives the spatial effects that the listener 106 is accustomed to perceiving. Additionally, the HRTF compensator circuit 204 can cancel the HRTF associated with the position of the parametric speaker 102 relative to the ear of the listener 106. This canceling of the HRTF can cancel directionality perceived by the listener 106, such that the listener 106 can perceive that the sound is entering the ear canal at a direction orthogonal to the head orientation of the listener 106. In the example where two parametric speakers are used to direct independent ultrasonic beams to ears of the listener 106, HRTFs can be applied to left and right audio signals, thus creating a desired spatial effect from the perspective of the listener 106.

The steer circuit 112 also includes a delay circuit 206 that can be configured to compute delay coefficients for transducers of the parametric speaker 102, wherein the delay coefficients are used in connection with electronically forming and steering the ultrasonic beam emitted from the parametric speaker 102. As mentioned previously, delay coefficients computed for transducers in the transducer array of the parametric speaker 102 can be a function of a desired direction of transmittal of modulated signal emitted by each transducer.

The steer circuit 112 also includes a modulator circuit 208 that can modulate carrier ultrasound waves by the audio signal 114. The steer circuit 112 may also optionally include an energy reducer circuit 210 that is configured to reduce an amount of energy needed to operate the parametric speaker 102. Generally, transmitting the ultrasonic beam requires that the carrier waves maintain a particular amplitude, even when the audio signal 114 by which the carrier waves are modulates requires a relatively low amount of energy (e.g., there is a silent period in the audio signal 114). The energy reducer circuit 210 can add a relatively low-frequency signal (below 20 Hz) to the modulated carrier signals, which effectively reduces an amount of energy needed to transmit the carrier signals when there is a relatively small amount of energy in the audio signal 114. More specifically, the modulated signal can be received by the energy reducer circuit 210, and the energy reducer circuit 210 can compute an envelope signal required for transmittal over some buffer period (time range). The energy reducer circuit 210 can utilize a high pass filter to compute the envelope. Based upon size of the envelope, the energy reducer circuit 210 can insert a relatively low-frequency signal with the modulated signal. This may be particularly beneficial in situations where the energy in the audio signal 114 is relatively low.

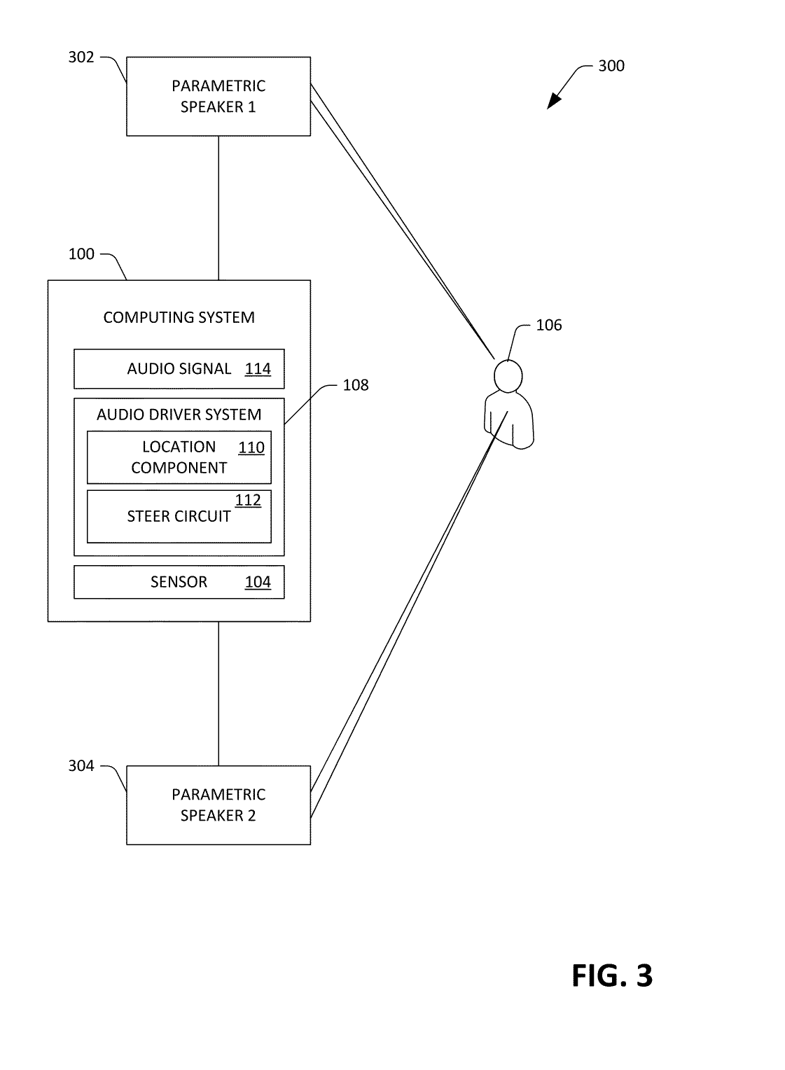

With reference now to FIG. 3, a functional block diagram of an exemplary system 300 that facilitates provision of a headphone-like experience to the listener 106 is illustrated. The system 300 comprises the sensor 104 and the audio driver system 108, which act as described above. In the system 300, the computing system 100 is in communication with a plurality of parametric speakers 302-304. In an example, it may be desirable for the first parametric speaker 302 to deliver sound to a first ear of the listener 106, while it may be desirable for the second parametric speaker 304 to deliver sound to a second ear of the listener 106.

The location component 110 can receive data from the sensor 104 and can identify locations of the ears of the listener 106 relative to the first parametric speaker 302 and the second parametric speaker 304, respectively. The steer component 112 can receive: 1) a first audio signal (e.g., a left audio signal) that is to be included in an ultrasonic beam output by the first parametric speaker 302; and 2) a second audio signal that is to be included in an ultrasonic beam output by the second parametric speaker 304. For instance, the first audio signal and the second audio signal may collectively be a stereo audio signal. In another example, the first audio signal and the second audio signal may be identical signals (e.g., a mono signal).

The steer component 112 can produce first ultrasonic carrier signals for the first parametric speaker 302 and can generate second ultrasonic carrier signals for the second parametric speaker 304. The steer component 112 can modulate the first ultrasound carrier signals by the first audio signal and can modulate the second ultrasonic carrier signals by the second audio signal to create first and second modulated signals, respectively. Based upon the location of the first ear of the listener 106, the steer component 112 can drive the first parametric speaker 302 to direct a main lobe of a first ultrasonic beam (which includes the first modulated signals) to the first ear of the listener 106 (with a focal point of the main lobe of the first ultrasonic beam being between the first parametric speaker 302 and the first ear of the listener 106). Further, based upon the location of the second ear of the listener 106, the steer component 112 can drive the second parametric speaker 304 to direct a main lobe of a second ultrasonic beam (which includes the second modulated signals) to the second ear of the listener 106 (with a focal point of the main lobe of the second ultrasonic beam being between the second parametric speaker 304 and the second ear of the listener 106). It can thus be ascertained that the listener 106 can be provided with a relatively high quality stereo audio experience, as well as a headphones-like experience.

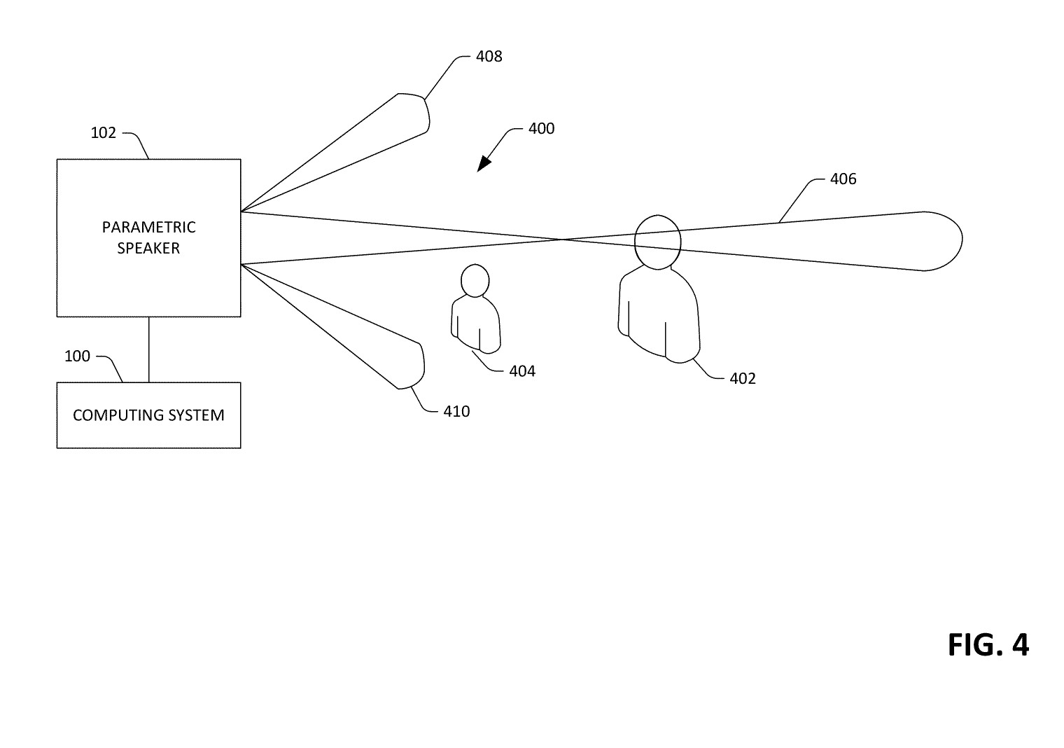

Turning now to FIG. 4, driving of the parametric speaker 102 to form an ultrasonic beam 400 such that a null region is at a desired location is illustrated. In the example shown in FIG. 4, it is desired to provide sound to a first listener 402, while it is desired to refrain from providing the sound to a second listener 404. It can be ascertained that when the transducer array in the parametric speaker 102 forms the ultrasonic beam 400, such beam 400 will include a main lobe 406 that includes a majority of the energy emitted by the transducers. The beam 400 will typically also include at least two side lobes 408 and 410. If the second listener 404 were to enter a region covered by the side lobes 408 or 410, for example, the second listener 404 will hear sound that is not intended to be heard by the second listener 404.

In this example, the location component 110 of the computing system 100 can identify locations (of heads) of both the first listener 402 and the second listener 404 relative to the parametric speaker 102. Further, the location component 110 can identify the first listener 402 as being the person to which sound is desirably transmitted (and the second listener 404 as being a person who is not to receive the sound). The steer circuit 112 can transmit drive signals to transducers of the parametric speaker 102, such that the formed ultrasonic beam 400 includes the main lobe 406 directed towards the first listener 402, while the second listener 404 is positioned in a null region of the beam 400. Forming the beam as a function of location of two (or more) listeners imposes a constraint on the shape of the beam 400, which may reduce quality of sound perceived by the first listener 402 or may require additional transmit energy to provide adequate sound to the first listener 102. The collective experience of the listeners 402 and 404, however, may be increased, as the second listener 404 is outside of primary energy regions of the ultrasonic beam 400. A similar technology can be employed to increase the left/right channel separation in a stereo application for a single user. More specifically, in this case, when computing the beam for the left channel of the stereo signal, the left ear is the first “listener” and the right ear is the second “listener” (and vice versa for the right channel).

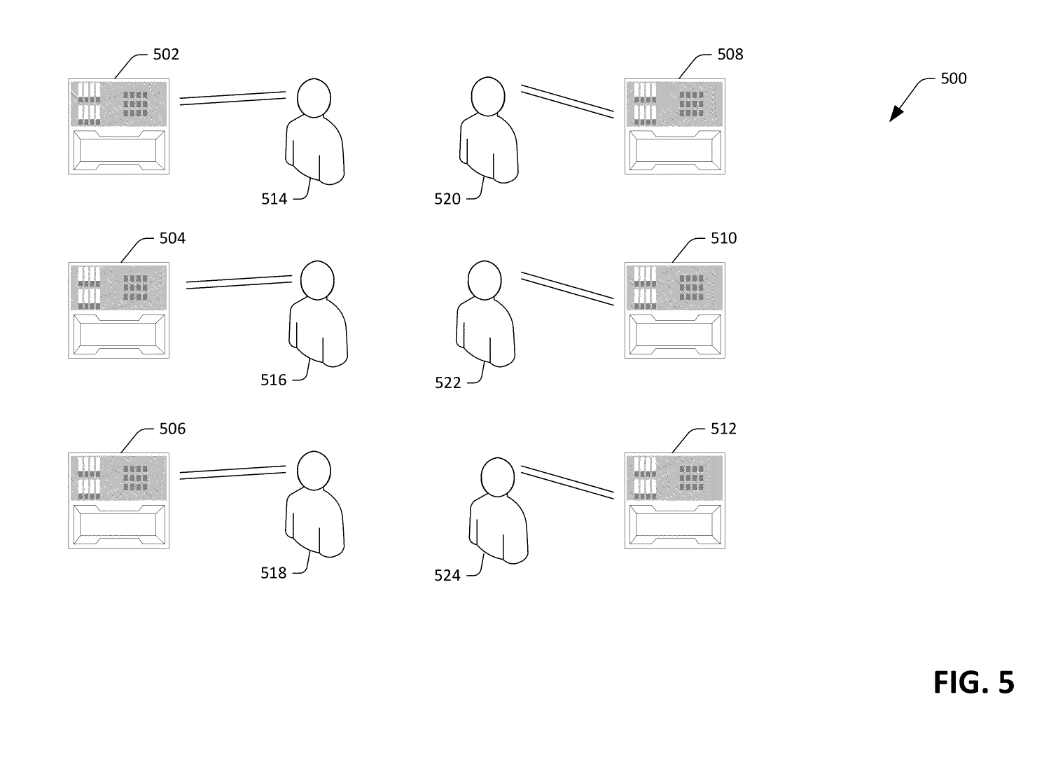

Now referring to FIG. 5, an exemplary environment 500 in which aspects described herein are particularly well suited is illustrated. The environment 500 may be an office setting, where many users 502-512 use respective telephones 514-524. For instance, the environment 500 may be an office setting where each of the users 502-512 has their own cubicle. In another example, the environment 500 may be a call center where the users 502-512 are frequently making and receiving telephone calls. Each of the telephones 514-524 can include at least one parametric speaker. A sensor may also be located in the environment 500 (e.g., in each telephone, in a room where locations of all the users 514-524 can be tracked, etc.), wherein the sensor(s) outputs data that is indicative of locations of the users 502-512 relative to the respective telephones 514-524.

The users 502-512, when making telephone calls, can be provided with sound from the parametric speakers of the telephones, where the sound can include spoken utterances of other parties on the telephone calls. The parametric speakers of the telephones 514-524, as described above, can be configured to direct main lobes of ultrasonic beams (encoded by audio) to the ears of the respective users 502-512. Accordingly, even though the first user 502 and the second user 504 may have adjacent cubicles, the second user 504 may not hear audio emitted from the parametric speaker of the first telephone 514, and the first user 502 may not hear audio emitted by the parametric speaker of the second telephone 516, since the parametric speakers 514 and 516 are configured to steer the ultrasonic beams as a function of locations of ears of the first user 502 and the second user 504, respectively. This provides users 502 and 504 with some measure of privacy while not burdening the users 502 and 504 with using handsets of the telephones 514 and 516 or earpieces. It can also be noted that in this and other cases where there are multiple uses in a region who are desirably not provided with sound, multiples nulls can be used, one aimed at the location of each of these users.

Referring now to FIG. 6, another exemplary environment 600 where aspects described herein may be particularly well 10 suited is illustrated. In this example, a mobile telephone 602 drives a parametric speaker 604. As shown, the mobile telephone 602 may be in wireless communication with the parametric speaker 604, wherein the mobile telephone 602 can include the audio driver system 108. The mobile phone 602 may have a camera thereon that can be used to determine a location of the listener 106 relative to the parametric speaker 604. In another example, the mobile telephone 602 may be in communication with the sensor 104, which may be external to the mobile telephone 602. The mobile telephone 602 can determine the location of the ears of the listener relative to the location of the parametric speaker 604 based upon the data output by the sensor 104. The parametric speaker 604, as described above, can be driven to direct a main lobe of an ultrasonic beam to the ears of the listener 106, wherein the ultrasonic beam is modulated by an audio signal that is intended to be provided to an ear of the listener 106. In this example, as the mobile telephone 602 and the parametric speaker 604 are battery-powered, it is desirable to reduce an amount of energy when transmitting signals, thus extending the battery life. Accordingly, the operation of the energy reducer circuit 210 is particularly well-suited for the environment 600.

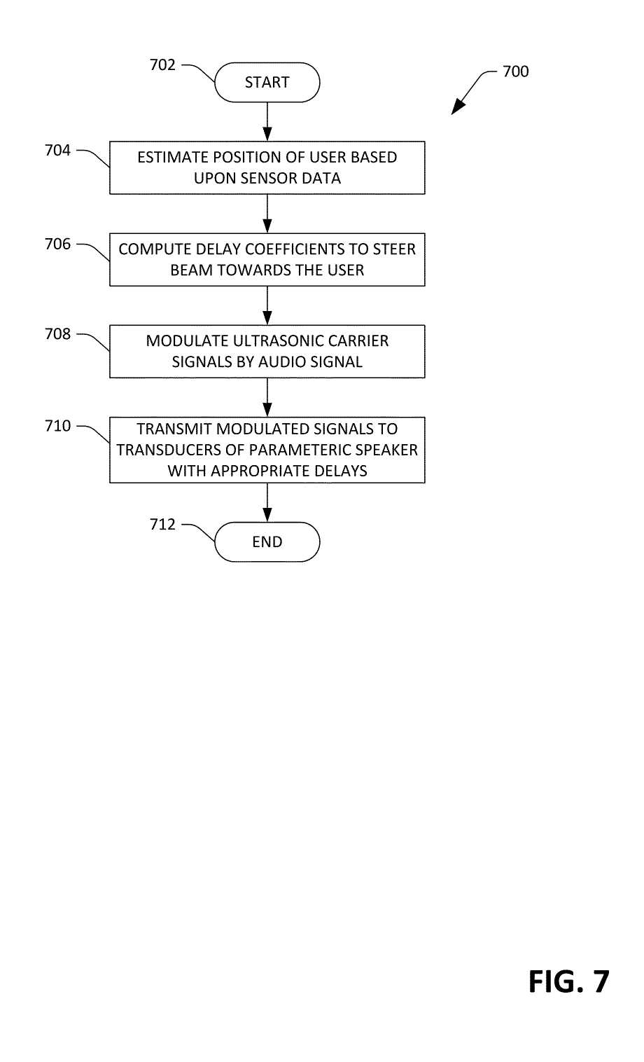

FIGS. 7-10 illustrate exemplary methodologies relating to steering ultrasonic beams, encoded with audio, based upon tracked location of ears of listeners. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Now referring to FIG. 7, an exemplary methodology 700 that facilitates driving a parametric speaker based upon a tracked location of an ear of a listener is illustrated. The methodology 700 starts at 702, and at 704 position of (an ear of) a user is estimated based upon data output by a sensor. As indicated previously, the sensor may be or include a camera, a depth sensor, or the like. At 706, based upon the position of the ear of the user (estimated at 704), delay coefficients for transducers of a transducer array of a parametric speaker are computed, wherein the delay coefficients can be used to electronically steer a main lobe (or side lobe) of an ultrasonic beam (output by the parametric speaker) to the ear of the user.

At 708, ultrasonic carrier signals are modulated by an audio signal that is to be provided to the user, thereby creating modulated signals. At 710, the modulated signals are transmitted to the transducers in the transducer array of the parametric speaker, wherein the modulated signals are delayed based upon respective delay coefficients computed at 706. The methodology 700 completes at 712.

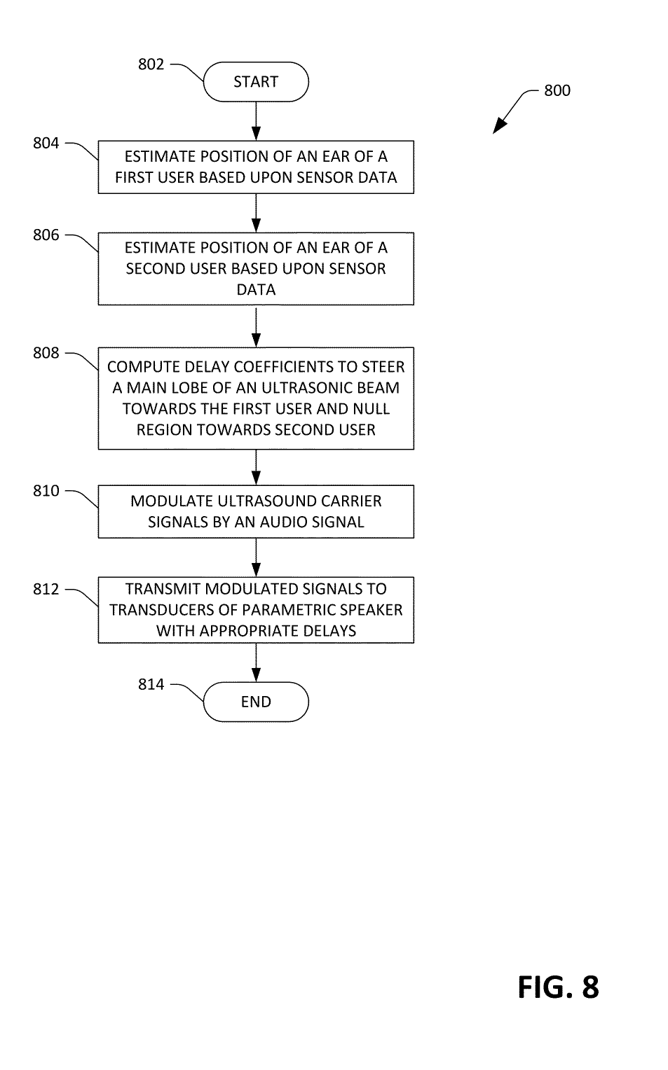

Referring now to FIG. 8, an exemplary methodology 800 that facilitates forming and steering an ultrasonic beam based upon locations of multiple users in a region is illustrated. The methodology 800 starts at 802, and at 804, position of an ear of a first user is estimated based upon received sensor data. At 806, position of an ear of a second user is estimated based upon the received sensor data. For example, it may be desirable for the first user to hear sound, while it may be undesirable for the second user to hear sound. In another example, it may be desirable for the first user to hear first sound and a second user to hear second sound (e.g., background sound).

At 808, for example, delay coefficients can be computed to form an ultrasonic beam, where a main lobe of the ultrasonic beam is directed towards the ear of the first user and a null region is directed towards the second user. At 810, ultrasonic carrier signals are modulated by the audio signal that is to be transmitted to the first user, thus generating modulated signals. At 812, the modulated signals are transmitted to respective transducers of the parametric speaker, wherein the modulated signals are respectively delayed based upon the delay coefficients computed at 808. The methodology 800 completes at 814.

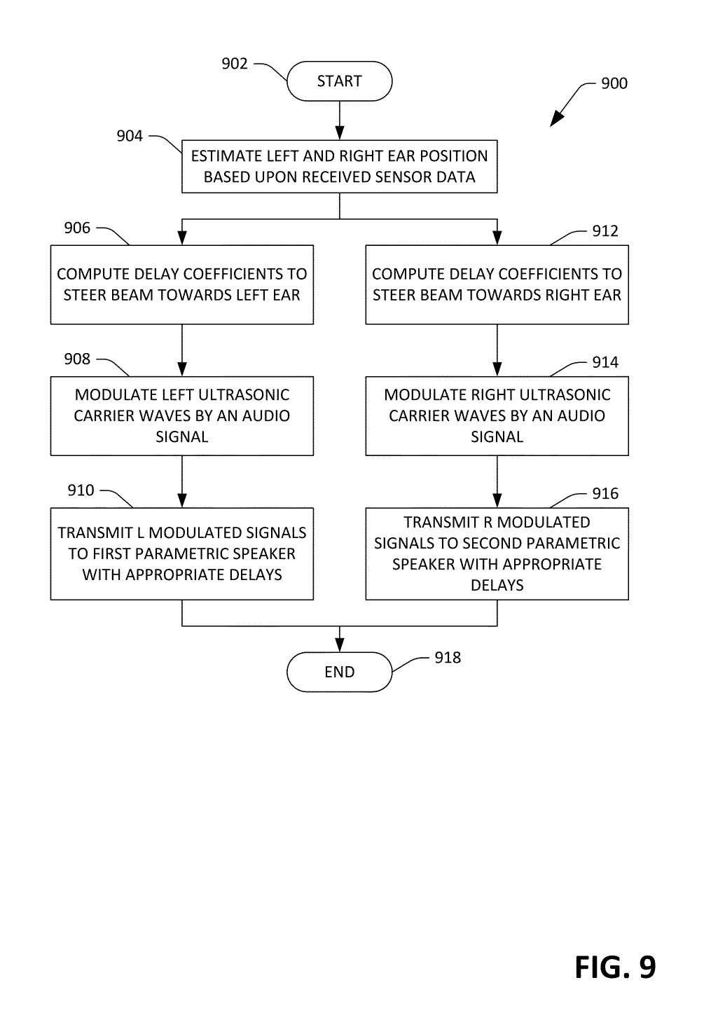

Referring now to FIG. 9, an exemplary methodology 900 that facilitates provision of sound to two ears of a user from two parametric speakers illustrated. The methodology 900 starts at 902, and at 904, left and right ear positions of a user are estimated based upon received sensor data. The left and right ear positions can be relative to a first parametric speaker and a second parametric speaker, respectively. The methodology 900 proceeds to 906, where delay coefficients are computed to cause the first parametric speaker to direct a main lobe of an ultrasonic beam to the left ear of the user, wherein such delay coefficients are computed based upon the estimated left ear position. At 908, left ultrasonic carrier signals for the first parametric speaker are modulated by a left audio signal, thereby creating left modulated signals. At 910, the left modulated signals are transmitted to respective transducers of the first parametric speaker, wherein the left modulated signals are appropriately delayed based upon the delay coefficients computed at 906.

In parallel to acts 906-910, at 912, delay coefficients are computed to cause the second parametric speaker to direct a main lobe of an ultrasonic beam to the right ear of the user. At 914, right ultrasonic carrier signals are modulated by a right audio signal (that is intended to be received at the right ear of the user), thereby forming right modulated signals. At 916, the right modulated signals are transmitted to respective transducers of the second parametric speaker, wherein the right modulated signals are delayed based upon the delay coefficients computed at 912. The result is that the user is provided with a high-quality stereo experience with audio delivered directly to the left and right ear of the user. Further, as referenced above, a single parametric speaker can be driven to form two (or more) ultrasonic beams, directed towards, for example, the two ears of the listener. The methodology 900 completes at 918.

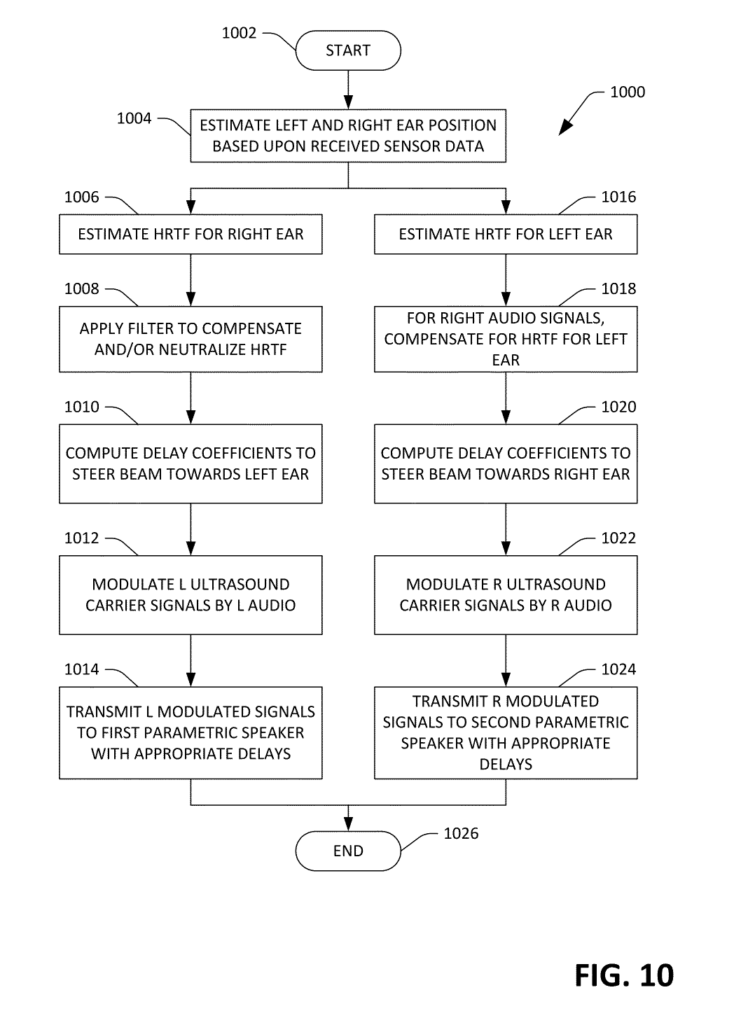

Now referring to FIG. 10, another exemplary methodology 1000 for delivering sound to the left and right ear of a user is illustrated. The methodology 1000 starts 1002, and at 1004, left and right ear positions of the user are estimated relative to a left parametric speaker and a right parametric speaker. The left and right ear positions can be estimated based upon data received from a sensor. At 1006, a HRTF is estimated for a left ear of the user based upon the estimated position of the left ear relative to the left and/or right parametric speakers.

At 1008, for a left audio signal (to be provided to the left ear), a filter is applied that compensates and/or neutralizes the HRTF for the right ear computed at 1006. This filter can mask the fact that the sound has a direction (e.g., from the left parametric speaker to the left ear) and/or introduce spatial effects that may be lost by incorporating sound directly in the left ear canal. At 1010, delay coefficients that electronically steer a main lobe of an ultrasonic beam to the left ear of the user are computed for signals provided to respective transducers in the transducer array of the parametric speaker. At 1012, left ultrasonic carrier signals are modulated by a left audio signal (representing sound to be heard in the left hear of the user), thereby generating left modulated signals. At 1014, the left modulated signals are provided to the respective transducers of the left parametric speaker, wherein the left modulated signals are respectively delayed based upon the delay coefficients computed at 1010.

In parallel with acts 1006-1014, at 1016, an HRTF for the left ear of the user is estimated based upon the position of the left ear estimated at 1004. At 1018, for the right audio signal (the audio signal that represents sound to be heard at the right ear of the listener), a filter is applied that compensates and/or neutralizes the HRTF estimated at 1016. As mentioned previously, the filter can mask directionality of the sound heard at the right ear of the listener and/or introduce desired spatial effects to be perceived by the user. At 1020, delay coefficients are computed to cause the right parametric speaker to steer a main lobe of an ultrasonic beam towards the right ear of the listener. At 1022, ultrasonic carrier signals for the right parametric speaker are modulated by a right audio signal, thus forming right modulated signals. At 1024, the right modulated signals are transmitted to the respective transducers of the right parametric speaker, wherein the right modulated signals are respectively delayed based upon the delay coefficients computed at 1020. The methodology 1000 completes 1026.

Various examples are now set forth.

### Example 1

A system that is configured to drive a parametric speaker, the system comprising: a location component that computes a location of an ear of a listener relative to the parametric speaker; and a steer circuit that transmits drive signals to the parametric speaker that causes the parameteric speaker to emit an ultrasonic beam toward the ear of the listener, the ultrasonic beam comprises a plurality of modulated signals, the modulated signals being ultrasonic carrier signals modulated by an audio signal, the drive signals based upon the location computed by the location component, a main lobe of the ultrasonic beam having a focal point between the parametric speaker and the ear of the listener.

### Example 2

The system according to example 1 comprised by a telephone.

### Example 3

The system according to example 1 comprised by a video game console.

### Example 4

The system according to any of examples 1-3, wherein the drive signals transmitted by the steer circuit to the parametric speaker further causes the listener to perceive that sound based upon the audio signal originates from a virtual sound source that is between the parametric speaker and the ear of the listener.

### Example 5

The system according to any of examples 1-4, wherein the steer circuit comprises a head-related transfer function (HTRF) estimator circuit that estimates a HRTF for the ear of the listener based upon the location of the ear of the listener, the signal transmitted by the steer circuit based upon the HRTF.

### Example 6

The system according to example 5, wherein the steer circuit further comprises a HRTF compensator circuit that applies a filter based upon the HRTF, the filter configured to mask directionality of sound heard by the ear of the listener, the sound based upon the audio signal.

### Example 7

The system according to example 5, wherein the steer circuit further comprises a HRTF compensator circuit that applies a filter based upon the HRTF, the filter configured to introduce special effects into sound heard by the ear of the listener, the sound based upon the audio signal.

### Example 8

The system according to any of examples 1-7, the signals cause the parametric speaker to electronically steer the ultrasonic beam towards the ear of the listener.

### Example 9

The system according to example 8, the steer circuit comprises a delay circuit that computes respective delay coefficients for the plurality of ultrasonic signals, the delay coefficients based upon the location of the ear of the listener, the steer circuit transmits the ultrasonic signals to respective transducers of the parametric speaker with delays that are based upon the delay coefficients.

### Example 10

The system according to any of examples 1-7, the parametric speaker comprises transducers and actuators that are configured to respectively mechanically drive the transducers, the signals drive the actuators to cause the parametric speaker to mechanically steer the ultrasonic beam towards the ear of the listener.

### Example 11

The system according to any of examples 1-10, the steer circuit comprises an energy reducer circuit, the energy reducer circuit estimates an envelope signal based upon amplitudes of a modulated signal in the modulated signals, the energy reducer circuit adds a low frequency signal to the modulated signal based upon the envelope signal.

### Example 12

The system according to any of examples 1-11, the location component receives at least one of an image or a depth image from a sensor, the location component computes the location of the ear of the listener based upon the at least one of the image or the depth image.

### Example 13

A method executed by a computing system, the method comprising: estimating location of an ear of a user based upon data received from a sensor; and based upon the location of the ear of the user, causing an ultrasonic beam to be emitted from a parametric speaker, the ultrasonic beam comprises modulated signals, the modulated signals being ultrasonic carrier signals that are modulated by an audio signal, the ultrasonic beam comprising a main lobe that is directed towards the location of the ear of the user and having a focal point between the parametric speaker and the ear of the user.

### Example 14

The method according to example 13, further comprising: estimating a location of another ear of another user based upon the data received from the sensor; and based upon the location of the another ear of the another user, causing the ultrasonic beam to be formed such that the another user is positioned in a null region of the ultrasonic beam.

### Example 15

The method according to any of examples 13-14, further comprising: estimating a location of another ear of the user based upon the data received from the sensor; based upon the location of the another ear of the user, causing another ultrasonic beam to be emitted from another parametric speaker, the another ultrasonic beam comprises a second plurality of modulated signals, the second plurality of modulated signals being second ultrasonic carrier signals that are modulated by a second audio signal, the another ultrasonic beam comprising another main lobe that is directed towards the location of the another ear of the user and having a focal point between the another parametric speaker and the another ear of the user.

### Example 16

The method according to any of examples 13-15, wherein causing the ultrasonic beam to be emitted from the parametric speaker comprises transmitting the modulated signals to the parametric speaker with respective delays, the modulate signals configured to electronically steer the ultrasonic beam.

### Example 17

The method according to any of examples 13-15, wherein causing the ultrasonic beam to be emitted from the parametric speaker comprises controlling actuators to position transducers of the parametric speaker such that the ultrasonic beam is mechanically steered.

### Example 18

The method according to any of examples 13-17, wherein causing the ultrasonic beam to be emitted from the parametric speaker comprises forming the ultrasonic beam based upon an identified location of another user.

### Example 19

The method according to example 18, wherein forming the ultrasonic beam based upon the identified location of the another user comprises causing a null region of the ultrasonic beam to encompass the another user, the null region being between the main lobe and a side lobe of the ultrasonic beam.

### Example 20

A computer-readable medium comprising instructions that, when executed by a processor, cause the processor to perform acts comprising: determining a location of an ear of a user relative to a parametric speaker, the parametric speaker comprising transducers; based upon the location of the ear of the user relative to the parametric speaker, computing delay coefficients of modulated signals that are to be transmitted by the transducers, respectively; generating ultrasonic carrier signals for the transducers; modulating the ultrasonic carrier signals by an audio signal to generate the modulated signals, the audio signal representative of sound to be heard by the ear of the user; transmitting the modulated signals to the transducers, the modulated signals delayed based upon the delay coefficients, the modulated signals causing the transducers to form an ultrasonic beam that has a main lobe directed towards the ear of the user, the modulated signals further causing the main lobe to have a focal point between the parametric speaker and the ear of the user.

### Example 21

A system, comprising: means for estimating location of an ear of a user based upon data received from a sensor; means for causing an ultrasonic beam to be emitted from a parametric speaker based upon the location of the ear of the user, the ultrasonic beam comprises modulated signals, the modulated signals being ultrasonic carrier signals that are modulated by an audio signal, the ultrasonic beam comprising a main lobe that is directed towards the location of the ear of the user and having a focal point between the parametric speaker and the ear of the user.

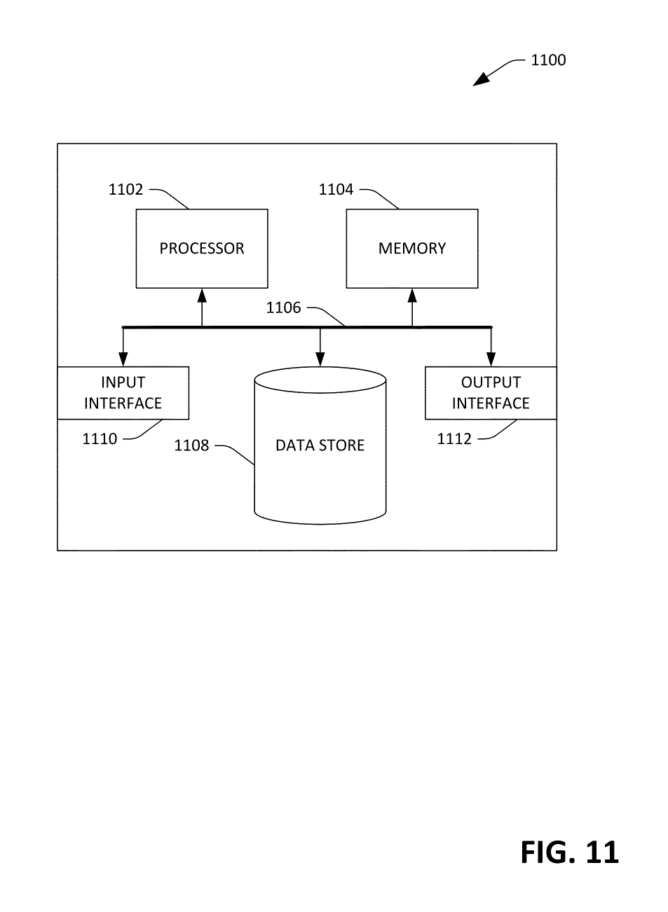

Referring now to FIG. 11, a high-level illustration of an exemplary computing device 1100 that can be used in accordance with the systems and methodologies disclosed herein is illustrated. For instance, the computing device 1100 may be used in a system that steers ultrasonic beams based upon identified locations of ears of a listener. By way of another example, the computing device 1100 can be used in a system that identifies locations of ears of a listener. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store audio signals, coefficient delays, HRTFs, etc.

The computing device 1100 additionally includes a data store 1108 that is accessible by the processor 1102 by way of the system bus 1106. The data store 1108 may include executable instructions, audio signals, HRTFs, coefficient delays, etc. The computing device 1100 also includes an input interface 1110 that allows external devices to communicate with the computing device 1100. For instance, the input interface 1110 may be used to receive instructions from an external computer device, from a user, etc. The computing device 1100 also includes an output interface 1112 that interfaces the computing device 1100 with one or more external devices. For example, the computing device 1100 may display text, images, etc. by way of the output interface 1112.

It is contemplated that the external devices that communicate with the computing device 1100 via the input interface 1110 and the output interface 1112 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1100 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1100 may be a distributed system. Thus, for instance, several devices may be in communication by way of a network connection and may collectively perform tasks described as being performed by the computing device 1100.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system that is configured to drive a parametric speaker, the system comprising:
a location component that is configured to compute a location of an ear of a listener relative to the parametric speaker; and
a steer circuit that is configured to transmit drive signals to the parametric speaker, the drive signals cause the parameteric speaker to emit an ultrasonic beam toward the ear of the listener, the ultrasonic beam comprises a plurality of modulated signals, the modulated signals being ultrasonic carrier signals modulated by an audio signal, the drive signals based upon the location computed by the location component, a main lobe of the ultrasonic beam having a focal point between the parametric speaker and the ear of the listener.

2. The system of claim 1 comprised by a telephone.

3. The system of claim 1 comprised by a video game console.

4. The system of claim 1, wherein the drive signals transmitted by the steer circuit to the parametric speaker further cause the listener to perceive that sound based upon the audio signal originates from a virtual sound source that is between the parametric speaker and the ear of the listener.

5. The system of claim 1, wherein the steer circuit comprises a head-related transfer function (HTRF) estimator circuit that is configured to estimate a HRTF for the ear of the listener based upon the location of the ear of the listener, the steer circuit configured to transmit the signal based upon the HRTF.

6. The system of claim 5, wherein the steer circuit further comprises a HRTF compensator circuit that is configured to apply a filter based upon the HRTF, the filter configured to mask directionality of sound heard by the ear of the listener, the sound based upon the audio signal.

7. The system of claim 5, wherein the steer circuit further comprises a HRTF compensator circuit that is configured to apply a filter based upon the HRTF, the filter configured to introduce spatial effects into sound heard by the ear of the listener, the sound based upon the audio signal.

8. The system of claim 1, the signals configured to cause the parametric speaker to electronically steer the ultrasonic beam towards the ear of the listener.

9. The system of claim 8, the steer circuit comprises a delay circuit that is configured to compute respective delay coefficients for the plurality of ultrasonic signals, the delay coefficients based upon the location of the ear of the listener, the steer circuit configured to transmit the ultrasonic signals to respective transducers of the parametric speaker with delays that are based upon the delay coefficients.

10. The system of claim 1, the parametric speaker comprises transducers and actuators that are configured to respectively mechanically drive the transducers, the signals configured to drive the actuators to cause the parametric speaker to mechanically steer the ultrasonic beam towards the ear of the listener.

11. The system of claim 1, the steer circuit comprises an energy reducer circuit, the energy reducer circuit configured to estimate an envelope signal based upon amplitudes of a modulated signal in the modulated signals, the energy reducer circuit configured to add a low frequency signal to the modulated signal based upon the envelope signal.

12. The system of claim 1, the location component configured to receive at least one of an image or a depth image from a sensor, the location component configured to compute the location of the ear of the listener based upon the at least one of the image or the depth image.

13. A method executed by a computing system, the method comprising:
estimating location of an ear of a user based upon data received from a sensor; and
based upon the location of the ear of the user, causing an ultrasonic beam to be emitted from a parametric speaker, the ultrasonic beam comprises modulated signals, the modulated signals being ultrasonic carrier signals that are modulated by an audio signal, the ultrasonic beam comprising a main lobe that is directed towards the location of the ear of the user and having a focal point between the parametric speaker and the ear of the user.

14. The method of claim 13, further comprising:
estimating a location of another ear of another user based upon the data received from the sensor; and
based upon the location of the another ear of the another user, causing the ultrasonic beam to be formed such that the another user is positioned in a null region of the ultrasonic beam.

15. The method of claim 13, further comprising:
estimating a location of another ear of the user based upon the data received from the sensor;
based upon the location of the another ear of the user, causing another ultrasonic beam to be emitted from another parametric speaker, the another ultrasonic beam comprises a second plurality of modulated signals, the second plurality of modulated signals being second ultrasonic carrier signals that are modulated by a second audio signal, the another ultrasonic beam comprising another main lobe that is directed towards the location of the another ear of the user and having a focal point between the another parametric speaker and the another ear of the user.

16. The method of claim 13, wherein causing the ultrasonic beam to be emitted from the parametric speaker comprises transmitting the modulated signals to the parametric speaker with respective delays, the modulate signals configured to electronically steer the ultrasonic beam.

17. The method of claim 13, wherein causing the ultrasonic beam to be emitted from the parametric speaker comprises controlling actuators to position transducers of the parametric speaker such that the ultrasonic beam is mechanically steered.

18. The method of claim 13, wherein causing the ultrasonic beam to be emitted from the parametric speaker comprises forming the ultrasonic beam based upon an identified location of another user.

19. The method of claim 18, wherein forming the ultrasonic beam based upon the identified location of the another user comprises causing a null region of the ultrasonic beam to encompass the another user, the null region being between the main lobe and a side lobe of the ultrasonic beam.

20. A computer-readable medium comprising instructions that, when executed by a processor, cause the processor to perform acts comprising:
determining a location of an ear of a user relative to a parametric speaker, the parametric speaker comprising transducers;
based upon the location of the ear of the user relative to the parametric speaker, computing delay coefficients of modulated signals that are to be transmitted by the transducers, respectively;
generating ultrasonic carrier signals for the transducers;
modulating the ultrasonic carrier signals by an audio signal to generate the modulated signals, the audio signal representative of sound to be heard by the ear of the user; and
transmitting the modulated signals to the transducers, the modulated signals delayed based upon the delay coefficients, the modulated signals causing the transducers to form an ultrasonic beam that has a main lobe directed towards the ear of the user, the modulated signals further causing the main lobe to have a focal point between the parametric speaker and the ear of the user.
